(19) United States
(12) Patent Application Publication
(10) Pub. No.: US 2005/0080217 A1
(43) Pub. Date: Apr. 14, 2005

(54) Method for producing oil-resistant elastomer and oil-resistant seal member

(76) Inventor: Hitoshi Shirasaka, Yokohama-shi (JP)

Correspondence Address: HUNTLEY & ASSOCIATES, 1105 NORTH MARKET STREET, P.O. BOX 948, WILMINGTON, DE, 19899-0948, US

(21) Appl. No.: 10/759,851

(22) Filed: Jan. 16, 2004

Related U.S. Application Data
(63) Continuation-in-part of application No. 10/011,303, filed on Dec. 5, 2001, now abandoned.

(30) Foreign Application Priority Data
Dec. 6, 2000 (JP) 2000-369701

(51) Int. Cl. C08G 18/00

(52) U.S. Cl. 528/44

(57) ABSTRACT

A method for producing an oil-resistant elastomer being cross-linked millable polyurethane obtained by polyaddition of at least one polyester diol and at least one diisocyanate, and oil-seal members made therefrom.

### CROSS-REFERENCE TO RELATED APPLICATION

This is a Continuation-in-Part of copending application Ser. No. 10/011,303, filed Dec. 5, 2001.

### BACKGROUND OF THE INVENTION

1. Field of the Invention

The present invention relates to a method for producing oil-resistant elastomers for use in industrial machinery transport any such as automobiles. More particularly, the invention relates to a method for producing oil-resistant elastomers useful for components which require oil resistance, such as oil-resistant seal members, such as O-rings, packings, and oil-seal members (for example, an oil-seal or a rod-seal packing used on a shaft or a rod), or hoses.

2. Background Art

Generally, rubber materials such as acrylonitrile-butadiene rubber (NBR), hydrogenated acrylonitrile-butadiene rubber (HNBR), polysulfide rubber, acrylic rubber, epichlorohydrin rubber, and fluoroelastomers are employed as elastomers having oil resistance to hydrocarbon oils and fats such as gasoline and grease. The molecular structure of any of these rubb.er materials contains, in a main chain or a side chain, a polar group including an atom such as nitrogen, oxygen, sulfur, or halogen.

Although elastomers formed from any of these rubber materials exhibit oil resistance, most of these materials have poor elastomer properties other than oil resistance. The poor elastomer properties may be attributed to the essential feature of the aforementioned molecular structure. Briefly, by introducing a polar group such as a nitrile group, molecular movement is restricted, resulting in deterioration in rubber elasticity and low-temperature characteristics. When oxygen or sulfur is introduced in the main chain, molecular movement is maintained, but mechanical strength of the elastomer becomes poor. Thus, attaining both oil resistance and basic physical properties such as mechanical strength, low-temperature resistance, heat resistance, and rubber elasticity is difficult.

### SUMMARY OF THE INVENTION

The present invention is based on the discovery that the aforementioned problems can be solved by use of an elastomer member formed of a poly-ester-urethane having a strictly limited composition.

The present invention accordingly provides a method for producing an oil-resistant elastomer and an elastomer member, such as an oil-resistant seal member, endowed with oil resistance as well as well-balanced physical properties; i.e., high mechanical strength with excellent low-temperature resistance, heat resistance, and rubber elasticity.

Specifically, in a first aspect of the present invention, there is provided a method for producing cross-linked, millable oil-resistant elastomers and oil-seal members made therefrom by polyaddition of at least one polyester diol and at least one diisocyanate, comprising the steps of:
selecting the kinds and blend proportions of the at least one polyester diol and the at least one diisocyanate, respectively, so that the resulting polyurethane has an ester group concentration of at least about 25 wt. % (5.7 mmol/g) and less than about 35 wt. % (8 mmol/g) and a urethane group of at least about 7 wt. % (1.2 mmol/g) and less than about 12 wt. % (2.0 mmol/g);
reacting the at least one polyester diol and at least one diisocyanate to produce a millable polyurethane; and
crosslinking the millable polyurethane with a curing agent to form an oil-resistant elastomer which has a rubber hardness of about JIS A 95° or less and an elongation at break of at least about 100%, wherein the elastomer exhibits a percent change in weight, when exposed to IRM 903 lubricating oil, of about 20% or less.

The at least one polyester diol can, and preferably does, comprise aliphatic polyester diol containing no side chain.

The polyester diol can, and in one preferred embodiment of the invention, does, consist essentially of aliphatic polyester diol containing no side chain.

The polyester diol can, and in one preferred embodiment of the invention, does, comprise poly(ε-caprolactone diol).

The polyester diol can, and in one preferred embodiment of the invention, does, consist essentially poly(ε-caprolactone diol).

The oil-resistant elastomer can, and in one preferred embodiment of the invention, does, have a glass transition temperature of about −30° C. or lower.

In a second aspect of the present invention, there is provided an oil-seal member which is formed from at least one oil-resistant elastomer; wherein the oil-resistant elastomer has a rubber hardness of about JIS A 95° or less and an elongation at break of at least 100%, the elastomer being cross-linked millable polyurethane obtained by polyaddition of at least one polyester diol and at least one diisocyanate, wherein the polyurethane has an ester group concentration of at least about 25 wt. % (5.7 mmol/g) and less than about 35 wt. % (8 mmol/g) and a urethane group concentration of at least about 7 wt. % (1.2 mmol/g) and less than about 12 wt. % (2.0 mmol/g), wherein the elastomer exhibits a percent change in weight, when exposed to IRM 903 lubricating oil, of about 20% or less.

The at least one polyester diol can, and preferably does, comprise aliphatic polyester diol containing no side chain.

The polyester diol can, and in one preferred embodiment of the invention, does, consist essentially of aliphatic polyester diol containing no side chain.

The polyester diol can, and in one preferred embodiment of the invention, does, comprise poly(ε-caprolactone diol).

The polyester diol can, and in one preferred embodiment of the invention, does, consists essentially of poly(ε-caprolactone diol).

The oil-seal member can, and in one preferred embodiment of the invention, does, have a glass transition temperature of about −30° C. or lower.

Various other objects, features, and many of the attendant advantages of the present invention will be readily appreciated as the same becomes better understood with reference to the following detailed description of the preferred embodiments when considered in connection with accompanying drawing.

### BRIEF DESCRIPTION OF THE DRAWING

FIG. 1 is a cross-sectional view of an oil-seal member of the present invention.

### DETAILED DESCRIPTION OF PREFERRED EMBODIMENTS

In the present invention, the polyester composition of an elastomer formed through cross-linking of a polyurethane obtained through polyaddition of polyester diol and diisocyanate is limited, to thereby provide an elastomer endowed with oil resistance as well as well-balanced physical properties; i.e., high mechanical strength with excellent low-temperature resistance, heat resistance, and rubber elasticity.

Examples of the polyester diol which can be used in the present invention include poly(ε-caprolactone diol) which is formed through an addition reaction of ε-caprolactone and a C2-C9 linear glycol serving as a starting diol such as ethylene glycol or 1,4-butylene glycol, and aliphatic polyester diols which are formed through polycondensation of a C2-C9 linear glycol and a C2-C8 linear dibasic acid.

Examples of the diisocyanate which can be caused to react with polyester diol include 2,4-toluene diisocyanate (TDI), 4 4′-diphenylmethane diisocyanate (MDI), p-phenylene diisocyanate (PPDI), 1,5-naphthalene diisocyanate (NDI), and 3,3-dimethyldiphenyl-4,4′-diisocyanate (tolidine diisocyanate) (TODI).

Examples of particularly preferred polyurethanes for constituting the elastomer member of the present invention include a polyurethane formed from poly(ε-caprolactone diol) and MDI.

In the present invention, the above-described polyester diol, which is a long chain polyol, is used as a main component of the polyol. In addition thereto, common chain extenders can be used in amounts that do not disrupt the desired properties of the final products. Examples of chain extenders that can be used include straight chain glycols having 2 to 12 carbon atoms in the main chain, such as ethylene glycol, thiodiethanol, propylene glycol, and butylene glycol; diols having an aromatic ring and having up to 12 carbon atoms, such as 1,4-bis(hydroxyethoxy)benzene and p-xylene glycol and hydrogenated products thereof. Additionally, triols such as trimethylol; or stearyl alcohol, hydroxyethyl acrylate, and the like can also be used.

In the case where the polyurethane obtained by the method of the present invention is crosslinked with sulfur, a compound having an unsaturated bond is typically used as a part of the polymerization initiator or chain extender in accordance with conventional manner.

In the method of the present invention, an oil-resistant elastomer being cross-linked millable polyurethane obtained by polyaddition of at least one polyester diol and at least one diisocyanate is obtained by the steps of: selecting the kinds of the at least one polyester diol and at least one diisocyanate and blend of the at least one polyester diol to the at least one diisocyanate, respectively, whereby the resulting polyurethane has an ester group concentration of at least about 25 wt. % (5.7 mmol/g) and less than about 35 wt. % (8 mmol/g) and a urethane group concentration of at least about 7 wt. % (1.2 mmol/g) and less than about 12 wt. % (2.0 mmol/g), reacting the at least one polyester diol and at least one diisocyanate to produce a millable polyurethane, and crosslinking the millable polyurethane with a curing agent to form an oil-resistant elastomer which has a rubber hardness of about JIS A 95° or less and an elongation at break of at least 100%, wherein the elastomer exhibits a percent change in weight, when exposed to IRM 903 lubricating oil, of 20% or less.

Here, the at least one polyester diol and at least one diisocyanate are selected in the above-mentioned examples, respectively. The blend proportions of polyester diol and the at least one diisocyanate can be within generally used ranges, on the condition that the resulting polyurethane has an ester group concentration of at least about 25 wt. % (5.7 mmol/g) and less than about 35 wt. % (8 mmol/g) and a urethane group concentration of at least about 7 wt. % (1.2 mmol/g) and less than about 12 wt. % (2.0 mmol/g). For example, active hydrogen such as hydroxyl group in the diol and isocyanate are blended in equimolar amounts. More specifically, for example, 25 parts by weight of MDI per 100 parts by weight of the diol is used for a hydroxyl number (OHv: KOHmg/g) of 112, 20.8 parts by weight of MDI per 100 parts by weight of diol for OHv of 94, 16.7 parts by weight of MDI per 100 parts by weight of diol for OHv of 75.

Next, the millable polyurethane of the present invention is kneaded with a curing agent and heat cured (crosslinked). Examples of such a curing agent include organic peroxides, sulfur, organic sulfur-containing compounds, isocyanates, and the like for ordinary synthetic rubbers. In the method of the present invention, generally, organic peroxides are preferred. Examples of the organic peroxides include dicumyl peroxide, a,a′-bis(t-butylperoxyisopropyl)benzene, and the like. The amount of the organic peroxide to be added is generally about from 0.5 to 10 parts by weight, and preferably 1.5 to 5 parts by weight, per 100 parts by weight of combined polyester diol and isocyanate. It is in the case where the polymerization initiator or chain extender has an unsaturated bond, such as 3-allyl-1,2-propanediol, that sulfur and organic sulfur containing compounds can be used as a curing agent. Examples of the organic sulfur-containing compounds include zinc chloride complex of 2-mercaptobenzo thiazole, and the like.

Upon kneading and curing as described above, commonly used additives, i.e., reinforcing materials such as carbon black, silica, etc., detackifiers such as wax, plasticizers such as tributyl trimellitate (TBTM), tetrabutyl pyromellitate (TBPM), dibutyl phthalate (DBP) can be used. Here, in the present invention, general plasticizers such as dioctyl phthalate (DOP) is not desirable because a low-polarity plasticizer isn't desirable.

The polyurethane of the present invention can contain a hydrolysis preventing agent such as polycarbodiimide in amounts of about from 0.2 to 3 parts by weight per 100 parts by weight of the polyurethane in the same manner as in conventional methods. The polyurethane members of the present invention exhibit improved hydrolysis resistance twice or more as high as conventional thermosetting millable polyurethanes. Accordingly, the use of hydrolysis preventing agents in the polyurethane of the present invention in the same amount as the conventional polyurethanes the hydrolysis resistance of the polyurethane material of the present invention is increased accordingly while in order to obtain the same level of hydrolysis resistance as the conventional polyurethane materials, the amount of the additive to be added can be reduced by about from 20% to 50% of the amount of the conventional additive. This contributes much to reduction in costs since the hydrolysis preventing agents are generally expensive.

The millable polyurethane of the present invention can be reacted under the conditions of generally about from 70° C. to 150° C. for about from 30 to 10 hours and thereafter aged if necessary at 40° C. to 120° C. for about 6 to 48 hours. The heat curing conditions of the millable polyurethane can be determined depending on the decomposition properties of the organic peroxide used but generally it is preferred that the heat curing conditions are set within the range of about from 150 to 180° C. for about from 3 to 60 minutes.

The oil-seal members of the present invention are formed by the method of the present invention, that is, crosslinking the above millable polyurethane with a curing agent and molding the resulting cured polyurethane to form an oil-seal member, such as O-rings and packings. A representative oil-seal member is shown in cross-section view in the figure.

### EXAMPLES

The present invention will next be described in detail by way of examples, which should not be construed as limiting the invention thereto. The oil-resistant rubber according to the present invention has been compared with NBR, HNBR, and millable poly-ester-urethane, which are generally employed as oil-resistant rubber.

### Example 1

ε-Caprolactone and 1,4-butylene glycol serving as a starting diol were subjected to an addition reaction, to thereby yield a polyester diol having a hydroxyl value of 110. The polyester diol and MDI were subjected to polyaddition such that the amount of hydroxyl groups and that of isocyanate are adjusted to be equimolar, to thereby yield a polyurethane rubber. The thus-formed polyurethane rubber had an ester group concentration of 28% and a urethane group concentration of 9.3%.

Dicumyl peroxide (Percumyl D, product of Nippon Oil & Fats Co., Ltd.) (2 parts by weight) was added to the obtained polyurethane rubber (100 parts by weight), and the resultant mixture was press-formed at 160° C. for 20 minutes, to thereby yield an elastomer.

### Comparative Example 1

The procedure in Example 1 was repeated, except that commercially available HNBR (constituent acrylonitrile amount: 36%, iodine value: 28 g/100 g) (Zetpol 1020, product of Nippon Zeon Co., Ltd.) was used, to thereby yield an elastomer.

### Comparative Example 2

The procedure in Example 1 was repeated, except that commercially available NBR (constituent acrylonitrile amount: 50%) (Nipol DN003, product of Nippon Zeon Co., Ltd.) was used, to thereby yield an elastomer.

### Comparative Example 3

The procedure in Example 1 was repeated, except that commercially available NBR (constituent acrylonitrile amount: 35%) (N230S, product of Japan Synthetic Rubber Co., Ltd.) was used, to thereby yield an elastomer.

### Comparative Example 4

The procedure in Example 1 was repeated, except that commercially available NBR (constituent acrylonitrile amount: 18%) (Nipol DN401 L, product of Nippon Zeon Co., Ltd.) was used, to thereby yield an elastomer.

### Test Example 1

Each of elastomer samples obtained in Example 1 and Comparative Examples 1 to 4 was evaluated in terms of general physical properties. Table 1 shows the results. Hardness (JIS A) was measured in accordance with JIS K6253 (corresponding to ASTM D2240). Rebound resilience (%) was measured in accordance with JIS K6255 (corresponding to ISO 4462). Compressive permanent strain (%) was measured in accordance with JIS K6262(corresponding to ISO 815 and ISO/DIS 2285). Tensile strength (MPa) was measured in accordance with JIS K6251 (corresponding to ISO 37). Elongation at break (%) was measured in accordance with JIS K6251 (corresponding to ISO 37).

TABLE 1

| | | Comp. | Comp. | Comp. | Comp. |
|---|---|---|---|---|---|
| | Ex. 1 | Ex. 1 | Ex. 2 | Ex. 3 | Ex. 4 |
| Amount of constituent | — | 36 | 50 | 35 | 18 |
| acrylonitrile (%) | | | | | |
| Hardness (JIS A) | 54 | 50 | 52 | 53 | 58 |
| Rebound resilience (%) | 73 | 69 | 10 | 57 | 80 |
| Compressive permanent | 8 | 17 | 7 | 2 | breakage |
| strain (%) | | | | | |
| Tensile strength (MPa) | 12.3 | 8.4 | 7.2 | 2.8 | 1.1 |
| Elongation at break (%) | 600 | 630 | 490 | 190 | 20 |
| Glass transition temp. | −38 | −29 | −4 | −26 | −46 |
| (° C.) | | | | | |

As shown in Table 1, the sample in Example 1 shows remarkably high mechanical strength. NBR samples in Comparative Examples 1 to 4 exhibit upward shift of glass transition temperature with increasing nitrile content, leading to deterioration of low-temperature resistance. The glass transition temperature of the sample in Example 1 is lower than that of the samples in Comparative Examples 1 to 3 having an intermediate to high nitrile content, and nearly equal to that of the sample in Comparative Example 4 having a low nitrile content. The sample in Example 1 shows high rebound resilience, which is an index of rubber elasticity. Similar to the case of glass transition temperature, rebound resilience of NBR samples in the Comparative Examples is observed to depend on the nitrile content.

### Test Example 2

Each of elastomer samples obtained in Example 1 Comparative Examples 1 to 4 was evaluated in terms of oil resistance. Table 2 shows the results. Oil resistance to lubricating oil was evaluated on the basis of physical properties after completion of immersion of each sample in ASTM No.3 oil at 100° C. for 72 hours. Oil resistance to fuel oil was evaluated on the basis of physical properties after completion of immersion of each sample in FUEL C (isooctane/toluene=50/50 vol. %) at 40° C. for 72 hours. Hardness (JIS A), tensile strength, and elongation at break were measured in a manner similar to that employed in Test Example 1, and the percent increase in weight (%) was measured in accordance with JIS K6258 (corresponding to ISO 1817).

TABLE 2

| | | | Comp. | Comp. | Comp. | Comp. |
|---|---|---|---|---|---|---|
| | | Ex. 1 | Ex. 1 | Ex. 2 | Ex. 3 | Ex. 4 |
| Lubricating | Hardness | 46 | 40 | 54 | 53 | 57 |
| oil | (JIS A) | | | | | |
| | Tensile strength (MPa) | 13.4 | 3.3 | 3.4 | 1.7 | breakage |
| | Elongation at break (%) | 460 | 370 | 260 | 100 | breakage |
| | Percent increase in | 6.9 | 21.4 | 1.2 | 18.9 | 49 |
| | weight (%) | | | | | |
| Fuel oil | Hardness | 44 | 33 | 40 | 50 | 45 |
| | (JIS A) | | | | | |
| | Tensile strength (MPa) | 8.2 | 3.3 | 2.4 | breakage | breakage |
| | Elongation at break (%) | 410 | 440 | 260 | breakage | breakage |
| | Percent increase in | 32.9 | 64.7 | 31.2 | 55.5 | 100 |
| | weight (%) | | | | | |

As shown in Table 2, in terms of oil resistance to either lubricating oil (ASTM No. 3 oil) or fuel oil (FUEL C), the sample in Example 1 is much superior to the samples in Comparative Examples 1 and 3 having an intermediate to high nitrile content. The oil resistance of the sample in Example 1 is approximately equivalent to that of the sample in Comparative Example 2 having a very high nitrile content.

The swelling ratio of NBR samples of Comparative Examples 1 to 4 decreases as the nitrile content increases. However, the glass transition temperature, serving as an index of low-temperature resistance, is elevated, failing to attain both low-temperature resistance and oil resistance. In contrast, the sample in Example 1 shows excellent oil resistance while the glass transition temperature thereof remains low.

### Example 2

To the polyurethane rubber (100 parts by weight) which had been obtained in Example 1, carbon black (Seast SO, product of Tokai Carbon Co., Ltd.) (20 parts by weight), an age resister (Stabaxol P, product of Sumitomo Bayer Urethane Co., Ltd) (1.5 parts by weight), and a cross-linking agent (Percumyl D, product of Nippon Oil & Fats Co., Ltd.) (2 parts by weight) were added, and the resultant mixture was press-formed at 160° C. for 20 minutes, to thereby yield an elastomer sample.

### Comparative Examples 5 to 8

In a manner similar to that of Example 2, except that an age resister (Antage RD, product of Kawaguchi Chemical Industry Co., Ltd.) (1.5 parts by weight) was used, the above additives were added at the same compositional proportions to each of the polymers of Comparative Examples 1 to 4, to thereby yield a compound. A cross-linked elastomer was prepared from the compound.

### Test Example 3

Each of the elastomer samples obtained in Example 2 and Comparative Examples 5 to 8 was evaluated in terms of general physical properties. Table 3 shows the results. Hardness (JIS A), rebound resilience, compressive permanent strain, tensile strength, and elongation at break were measured in a similar manner to that employed in Test Example 1.

TABLE 3

| | | Comp. | Comp. | Comp. | Comp. |
|---|---|---|---|---|---|
| | Ex. 2 | Ex. 5 | Ex. 6 | Ex. 7 | Ex. 8 |
| Hardness (JIS A) | 64 | 58 | 63 | 60 | 62 |
| Rebound resilience (%) | 71 | 63 | 8 | 49 | 73 |
| Compressive | 13 | 14 | 15 | 3 | 2 |
| permanent strain (%) | | | | | |
| Tensile strength (MPa) | 29.1 | 25.2 | 20.3 | 10.6 | 4.5 |
| Elongation at break (%) | 490 | 800 | 600 | 250 | 150 |

As shown in Table 3, remarkable reinforce effect provided by carbon black is observed for NBR elastomers in Comparative Examples 5 to 8, but the tensile strength thereof is inferior to that of the NBR elastomer in Example 2.

### Test Example 4

Each of elastomer samples obtained in Example 2 and Comparative Examples 5 to 8 was evaluated in terms of heat-aging resistance (at 150° C.). Table 4 shows the physical properties measured after aging tests (after maintenance at 150° C. for 72 hours and at 150° C. for 168 hours). Hardness (JIS A), tensile strength, and elongation at break were measured in a similar manner to that employed in Test Example 1.

TABLE 4

| | | | Comp. | Comp. | Comp. | Comp. |
|---|---|---|---|---|---|---|
| | | Ex. 2 | Ex. 5 | Ex. 6 | Ex. 7 | Ex. 8 |
| 150° C. | Hardness | 63 | 62 | 96 | 81 | 85 |
| 72 hr | (JIS A) | | | | | |
| | Tensile strength | 26.4 | 23.7 | 12.1 | 6.9 | 2.4 |
| | (MPa) | | | | | |
| | Elongation at | 440 | 510 | 80 | 70 | 10 |
| | break | | | | | |
| | (%) | | | | | |
| 150° C. | Hardness | 60 | 65 | 99 | 99 | 97 |
| 168 hr | (JIS A) | | | | | |
| | Tensile strength | 18.2 | 14.7 | 16 | 7.3 | 4.3 |
| | (MPa) | | | | | |
| | Elongation at | 360 | 280 | 10 | 4 | 1 |
| | break | | | | | |
| | (%) | | | | | |

As shown in Table 4, NBR elastomers in Comparative Examples 5 to 8 exhibit a great amount of change in physical property, particularly hardness. Among these elastomers, HNBR in Comparative Example 5, prepared by hydrogenating remaining double bonds provided from butadiene, exhibits comparatively favorable maintenance in physical property. However, the elastomer sample in Example 2 has been found to exhibit superior maintenance in physical property.

### Example 3

Adipic acid and 1,4-butanediol linear glycol were subjected to polycondensation, to thereby yield a polyester diol having a hydroxyl value of 112. The polyester diol and MDI were subjected to polyaddition such that the amount of hydroxyl groups and that of isocyanate are adjusted to be equimol, to thereby yield a polyurethane rubber. The thus-formed polyurethane rubber had an ester group concentration of 32.0% and a urethane group concentration of 9.4%.

The urethane rubber and additives were mixed at the same compositional proportions as those employed in Example 1, to thereby yield a compound. A cross-linked elastomer was prepared from the compound.

### Example 4

Adipic acid and 1,4-butanediol/1,6-hexanediol (50/50 mol %) linear glycol were subjected to polycondensation, to thereby yield a polyester diol having a hydroxyl value of 96. The polyester diol and MDI were subjected to polyaddition such that the amount of hydroxyl groups and that of isocyanate are adjusted to be equimol, to thereby yield a polyurethane rubber. The thus-formed polyurethane rubber had an ester group concentration of 31% and a urethane group concentration of 8.3%.

The urethane rubber and additives were mixed at the same compositional proportions as those employed in Example 1, to thereby yield a compound. A cross-linked elastomer was prepared from the compound.

### Comparative Example 9

Adipic acid and ethylene glycol/1,4-butanediol (50/50 mol %) linear glycol were subjected to polycondensation, to thereby yield a polyester diol having a hydroxyl value of 56. The polyester diol and MDI were subjected to polyaddition such that the amount of hydroxyl groups and that of isocyanate are adjusted to be equimol, to thereby yield a polyurethane rubber. The thus-formed polyurethane rubber had an ester group concentration of 40.5% and a urethane group concentration of 5.2%.

The urethane rubber and additives were mixed at the same compositional proportions as those employed in Example 1, to thereby yield a compound. A cross-linked elastomer was prepared from the compound.

### Comparative Example 10

Adipic acid and 3-methyl-1,5-pentanediol glycol having a side-chain methyl group were subjected to polycondensation, to thereby yield a polyester diol having a hydroxyl value of 28. The polyester diol and MDI were subjected to polyaddition such that the amount of hydroxyl groups and that of isocyanate are adjusted to be equimol, to thereby yield a polyurethane rubber. The thus-formed polyurethane rubber had an ester group concentration of 35% and a urethane group concentration of 2.8%.

The urethane rubber and additives were mixed at the same compositional proportions as those employed in Example 1, to thereby yield a compound. A cross-linked elastomer was prepared from the compound.

### Comparative Example 11

ε-Caprolactone and ethylene glycol serving as a starting diol were subjected to an addition reaction, to thereby yield a polyester diol having a hydroxyl value of 155. The polyester diol and MDI were subjected to polyaddition such that the amount of hydroxyl groups and that of isocyanate are adjusted to be equimol, to thereby yield a polyurethane rubber. The thus-formed polyurethane rubber had an ester group concentration of 26% (6.0 mmol/g) and a urethane group concentration of 12.1% (2.1 mmol/g).

The urethane rubber and additives were mixed at the same compositional proportions as those employed in Example 1, to thereby yield a compound. A cross-linked elastomer was prepared from the compound.

### Comparative Example 12

Adipic acid and 1,6-hexanediol/neopentyl glycol(70/30 mol %) mixture of linear glycol and glycol having a side-chain group were subjected to polycondensation, to thereby yield a polyester diol having a hydroxyl value of 54. The polyester diol and MDI were subjected to polyaddition such that the amount of hydroxyl groups and that of isocyanate are adjusted to be equimol, to thereby yield a polyurethane rubber. The thus-formed polyurethane rubber had an ester group concentration of 27.0% and a urethane group concentration of 4.5%.

The urethane rubber and additives were mixed at the same compositional proportions as those employed in Example 1, to thereby yield a compound. A cross-linked elastomer was prepared from the compound.

### Comparative Example 13

Commercially available millable poly-ester-urethane (trade name, Urepan 640G) was used as a urethane rubber.

The urethane rubber and additives were mixed at the same compositional proportions as those employed in Example 1, to thereby yield a compound. A cross-linked elastomer was prepared from the compound.

### Comparative Example 14

Commercially available millable poly-ester-urethane (trade name, Urepan 641 G) was used as a urethane rubber.

The urethane rubber and additives were mixed at the same compositional proportions as those employed in Example 1, to thereby yield a compound. A cross-linked elastomer was prepared from the compound.

### Test Example 5

Each of millable poly-ester-urethane elastomer samples obtained in Examples 1, 3 and 4, and Comparative Examples 9 to 14 was evaluated in terms of general physical properties as the hydrolysis resistance; percent changes in hardness (ΔHs) and weight (ΔM) after immersion in IRM 903 oil (lubricating oil which highly swells an object, listed in ISO/DIS 1817) at 100° C. for 72 hours; and change in hardness (ΔHs) after the sample had been allowed to stand for 14 days at 85° C. and 95% RH. Table 5 shows the results. Hardness Hs (JIS A) was measured in accordance with JIS K6253. Rebound resilience Rb (%) was measured in accordance with JIS K6255. Tensile strength Tb (MPa) and elongation at break Eb (%) were measured in accordance with JIS K6251.

TABLE 5

| | | | | Comp. | Comp. | Comp. | Comp. | Comp. | Comp. |
|---|---|---|---|---|---|---|---|---|---|
| | Ex. 1 | Ex. 3 | Ex. 4 | Ex. 9 | Ex. 10 | Ex. 11 | Ex. 12 | Ex. 13 | Ex. 14 |
| Ester group concentration | 28 | 32 | 31 | 41 | 35 | 26 | 27 | — | — |
| wt. % | | | | | | | | | |
| Ester group concentration | 6.4 | 7.3 | 7.0 | 9.2 | 8.0 | 6.0 | 6.1 | — | — |
| mmol % | | | | | | | | | |
| Urethane group | 9.3 | 9.4 | 8.3 | 5.2 | 2.8 | 12.1 | 5.1 | — | — |
| concentration wt. % | | | | | | | | | |
| Urethane group | 1.6 | 1.6 | 1.4 | 0.9 | 0.5 | 2.1 | 0.9 | — | — |
| concentration mmol % | | | | | | | | | |
| Hardness (JIS A) | 54 | 55 | 53 | 55 | 48 | 58 | 54 | 56 | 55 |
| Rebound resilience (%) | 73 | 70 | 77 | 65 | 78 | 67 | 66 | 68 | 65 |
| Tensile strength (MPa) | 12.3 | 15.5 | 10.8 | 8.6 | 2.7 | 16.7 | 8.4 | 10.8 | 6.5 |
| Elongation at break (%) | 600 | 680 | 660 | 560 | 280 | 570 | 520 | 620 | 440 |
| Tg (° C.) | −38 | −36 | −40 | −42 | −54 | −26 | −44 | −42 | −35 |
| Oil resistance ΔHs | −3 | −3 | −4 | −9 | −5 | −1 | −5 | −5 | −4 |
| Oil resistance ΔM | 3.6 | 3.6 | 7.8 | 3.8 | 16.2 | 2.2 | 9.8 | 3.2 | 8.4 |
| Hydrolysis resistance ΔHs | −4 | −6 | −6 | −34 | −3 | −4 | −5 | −28 | −4 |

Table 5 provides comparison in physical properties of millable urethane elastomers having a variety of compositions. As shown in Table 5, the elastomer sample in Comparative Example 9 has considerably poor hydrolysis resistance conceivably due to an ester group concentration higher than the upper limit of the concentration range. The elastomer sample in Comparative Example 10 has poor mechanical strength, conceivably due to constituent polyester having a large amount of side-chain methyl groups. The elastomer sample in Comparative Example 11 has a high glass transition temperature (Tg) and poor low-temperature characteristics, conceivably due to a urethane group concentration higher than the upper limit of the concentration range. The sample of Comparative Example 12, which is formed from a polyester having a small amount of side-chain groups, exhibits poor mechanical strength and has a poor oil resistance as compared with the samples of Examples 3 and 4.

In contrast, elastomers in Examples 2 to 4, which are formed from a polyurethane having an ester group concentration of at least 25 wt. % (5.7 mmol/g) and less than 35 wt. % (8 mmol/g) and a urethane group concentration of at least 7 wt. % (1.2 mmol/g) and less than 12 wt. % (2.0 mmol/g), are found to be endowed with oil resistance and hydrolysis resistance as well as well-balanced physical properties; i.e., high mechanical strength with excellent low-temperature resistance and rubber elasticity.

### Example 5

ε-Caprolactone and 1,4-butylene glycol serving as a starting diol were subjected to an addition reaction, to thereby yield a polyester diol having a hydroxyl value of 110. The polyester diol and MDI were subjected to polyaddition such that the amount of hydroxyl groups and that of isocyanate are adjusted to be equimol, to thereby yield a polyurethane rubber. The thus-formed polyurethane rubber had an ester group concentration of 28% and a urethane group concentration of 9.3%.

Dicumyl peroxide (Percumyl D, product of Nippon Oil & Fats Co., Ltd.) (2 parts by weight) was added to the obtained polyurethane rubber (100 parts by weight), and the resultant mixture was press-formed at 160° C. for 20 minutes, to thereby yield an O-ring having shape illustrated FIG. 1.

### Example 6

To the polyurethane rubber (100 parts by weight) which had been obtained in Example 1, carbon black (Seast SO, product of Tokai Carbon Co., Ltd.) (20 parts by weight), an age resister (Stabaxol P, product of Sumitomo Bayer Urethane Co., Ltd) (1.5 parts by weight), and a cross-linking agent (Percumyl D, product of Nippon Oil & Fats Co., Ltd.) (2 parts by weight) were added, and the resultant mixture was press-formed at 160° C. for 20 minutes, to thereby yield a rod-seal packing illustrated FIG. 1. The rod-seal packing 10, which has an outside diameter of 18 mm, an inside diameter 8 mm and a height of 8 mm, can be used for oil-sealing in an oil pump in such a manner that it is pressed between a housing.

As described herein above, according to the present invention, excellent oil resistance as well as well-balanced physical properties such as high mechanical strength and high rubber elasticity can be attained while low-temperature resistance is maintained, these two properties having been difficult to be attained by nitrile rubber or hydrogenated nitrile rubber. Thus, an elastomer member, such as an oil-seal member, having excellent oil resistance as well as well-balanced physical properties, which are required for elastomers, can be provided.

1. A method for producing cross-linked, millable oil-resistant elastomers and oil-seal members made therefrom by polyaddition of at least one polyester diol and at least one diisocyanate, comprising the steps of:
selecting the kinds and blend proportion of the at least one polyester diol and the at least one diisocyanate, respectively, so that the resulting polyurethane has an ester group concentration of at least about 25 wt. % (5.7 mmol/g) and less than about 35 wt. % (8 mmol/g) and a urethane group concentration of at least about 7 wt. % (1.2 mmol/g) and less than about 12 wt. % (2.0 mmol/g);
reacting the at least one polyester diol and at least one diisocyanate to produce a millable polyurethane, and
crosslinking the millable polyurethane with a curing agent to form an oil-resistant elastomer which has a rubber hardness of JIS A 95° or less and an elongation at break of at least 100%, wherein the elastomer exhibits a percent change in weight, when exposed to IRM 903 lubricating oil, of 20% or less.

2. A method of claim 1, wherein the at least one polyester diol comprises aliphatic polyester diol containing no side chain.

3. A method of claim 2, wherein the polyester diol consists essentially aliphatic polyester diol containing no side chain.

4. A method of claim 1, wherein the polyester diol comprises poly(ε-caprolactone diol).

5. A method of claim 4, wherein the polyester diol consists essentially poly(ε-caprolactone diol).

6. A method for producing an oil-resistant elastomer of claim 1, which has a glass transition temperature of about −30° C. or lower.

7. An oil-seal member which is formed from at least one oil-resistant elastomer; wherein the oil-resistant elastomer has a rubber hardness of about JIS A 95° or less and an elongation at break of at least 100%, the elastomer being cross-linked millable polyurethane obtained by polyaddition of at least one polyester diol and at least one diisocyanate, wherein the polyurethane has an ester group concentration of at least about 25 wt. % (5.7 mmol/g) and less than about 35 wt. % (8 mmol/g) and a urethane group concentration of at least about 7 wt. % (1.2 mmol/g) and less than about 12 wt. % (2.0 mmol/g), wherein the elastomer exhibits a percent change in weight, when exposed to IRM 903 lubricating oil, of about 20% or less.

8. An oil-seal member of claim 7, wherein the at least one polyester diol comprises aliphatic polyester diol containing no side chain.

9. An oil-seal member of claim 8, wherein the polyester diol consists essentially aliphatic polyester diol containing no side chain.

10. An oil-seal member of claim 7 wherein the polyester diol comprises poly(ε-caprolactone diol).

11. An oil-seal member of claim 10, wherein the polyester diol consists essentially poly(ε-caprolactone diol).

12. An oil-seal member of claim 7, which has a glass transition temperature of −30° C. or lower.
